(19) United States
(12) Patent Application Publication
(10) Pub. No.: US 2022/0406218 A1
(43) Pub. Date: Dec. 22, 2022

(54) Educational Card Game for Chess

(71) Applicant: Kevin Bencini, Sunnyville, CA (US)

(72) Inventor: Kevin Bencini, Sunnyville, CA (US)

(21) Appl. No.: 17/349,709

(22) Filed: Jun. 16, 2021

(51) Int. Cl. G09B 19/22

(52) U.S. Cl. CPC G09B 19/22

(57) ABSTRACT

An educational card game that teaches chess and has a plurality of decks. Each deck has a character that teaches lessons about chess and then later applies the lessons via puzzles for the user to solve. The puzzle cards have solutions in chess notation, and a unique card is dedicated to teach chess notation. The cards offer annotation and visual aids to simplify complex chess strategies, tactics, and more in flashcard format. Each card is color coded and numbered for simple navigation and difficulty deciphering. A single card is dedicated to teach chess notation and is used as a reference card to help understand other cards that include chess notation.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

This invention focuses on a novel educational card game (Classification G09B19/22) that teaches chess (Classification A63F 2003/025) through novel methods in conjunction of creating or reproducing positions in chess games (Classification A63F 3/022).

There are a limited number of cards that teach chess, most of which are compliment to a chess set to show how the chess pieces move. There are a few other commercially available decks of chess cards that focus on how to arrive at various chess opening via chess notation; however, both types of chess cards don't suggest a sequential order to advance through the deck and lack any deep understanding of chess (e.g., the chess cards that focus on how to arrive at various chess openings use chess notation to show the moves that get to a specific opening, but lack educating the user the reasoning behind the moves or how to read chess notation). Additionally, both types of chess cards don't provide any feedback to the user for them to either test or consolidate their newly learned knowledge.

### BRIEF SUMMARY OF THE INVENTION

The novel cards improve the way chess is currently taught. Giving the user a fast-paced comprehensive study guide that builds knowledge upon itself in a sequential order based on chess skill level or knowledge. The cards have annotation to give the user a deep understanding of chess by revealing the potential reasons behind specific chess tactics, strategies, and more. After the user learns the knowledge on a specific card, a later card in the deck(s) tests or consolidates their knowledge by providing a way to apply their knowledge via chess puzzles. A single card is dedicated to teach chess notation and is used as a reference card to read other cards that include chess notation.

### BRIEF DESCRIPTION OF THE SEVERAL VIEWS OF THE DRAWING

FIG. 1 is the front of a single card that teaches a specific chess topic in detail.

FIG. 2 is the front side of a single card that reinforces learning of the chess topic from FIG. 1.

FIG. 3A is an array of the front side of the first half of a set of cards.

FIG. 3B is an array of the front side of the second half of a set of cards.

FIG. 4 is an array of the generic look of the back side of four different sets of cards.

FIG. 5 is the front and back of a unique reference card that teaches chess notation.

### DETAILED DESCRIPTION OF THE INVENTION

The invention consists of four sets of eighteen cards. Each set of cards have a uniquely themed back and color for easy navigation. Each card in each set is numbered one through eighteen to indicate the recommended order of the cards and for easy navigation. The first half of each set of cards educate the user about chess via appropriate chess positions (or where the pieces are on a chess board), visual aids (such as arrows, circles, and highlights), and text (on or off the chess board). The second half of each set includes chess puzzles that incorporate the chess lessons from the first half of the set. The puzzles have the solution on the same card of the puzzle, upside down in chess notation above the chess board that contains the puzzle. The rows and columns are labeled with numbers, and letters, respectively, which allow the user to use chess notation accurately. The cards are presented in a narrative format, where the chess King is presenting information to the user by the use of a speech bubble and text inside the speech bubble. The King has a variety of funny faces/expressions (or emojis), which may differ per card, to add a humorous point to the education. The cards carry a medieval themed background and the background is uniform for all the fronts of the chess cards, the background serves only for aesthetic purposes.

### DETAILED DESCRIPTION OF DRAWINGS

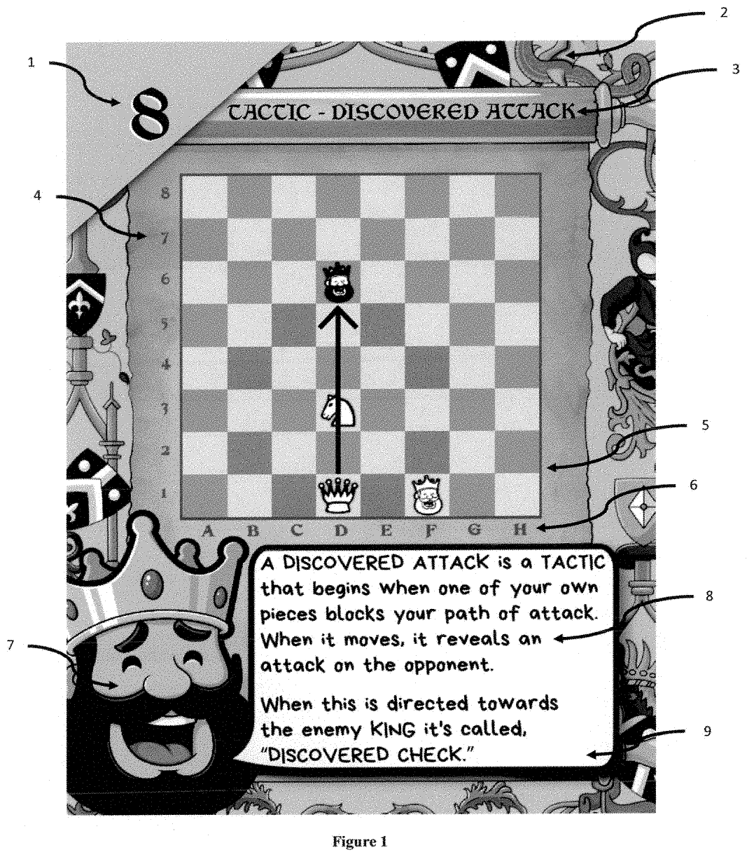

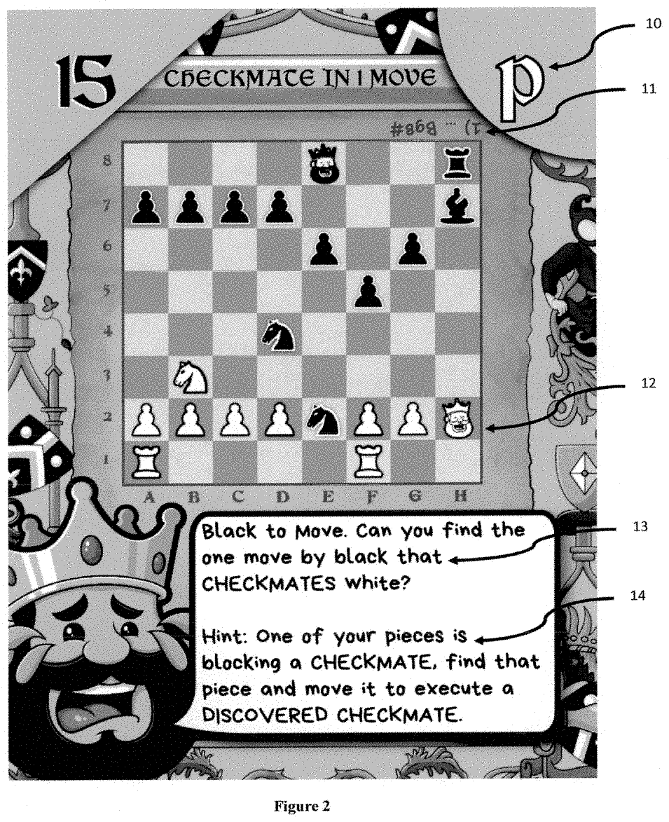

An educational card game that teaches chess methodically begins with two types of cards; FIG. 1 shows the front of a card that teaches a specific chess subject, FIG. 2 shows the front of a card that uses the taught chess subject and applies the subject to, but not limited to, a chess puzzle.

FIG. 1 reveals the general format of the front of a card that teaches a specific chess subject. The cards are each numbered 1 from one to eighteen to denote the recommended order of which the cards should be read. The cards reveal the subject being taught in the title 3 and the first paragraph 8 of the Speech Bubble 9. The Speech Bubble comes out from a character 7 that displays various emojis, which change per card. A chess board with chess pieces 5 laid out pertaining to the card's subject has an array of numbers 4, and letters 6 to specify the rows, and columns, respectively, on the chess board. All the components 1, 3, 4, 5, 6, 7, 8, 9 are laid in front of a background 2 that consists of dragons, vines, parchment paper, jester, a shield, and other miscellaneous medieval-themed objects that are used for aesthetic purposes only.

FIG. 2 reveals the general format of a card that applies the taught chess subject. A “P” 10 on the corner of the card indicates the card is a puzzle card, or a card that applies the taught chess subject. The title 3 and first paragraph 13 of the puzzle card explain the puzzle and the second paragraph 14 gives a hint. The solution 11 to the puzzle is written in chess notation, upside-side down. The chess board has pieces placed in a puzzle 12 with the chess scenario discussed in the second paragraph.

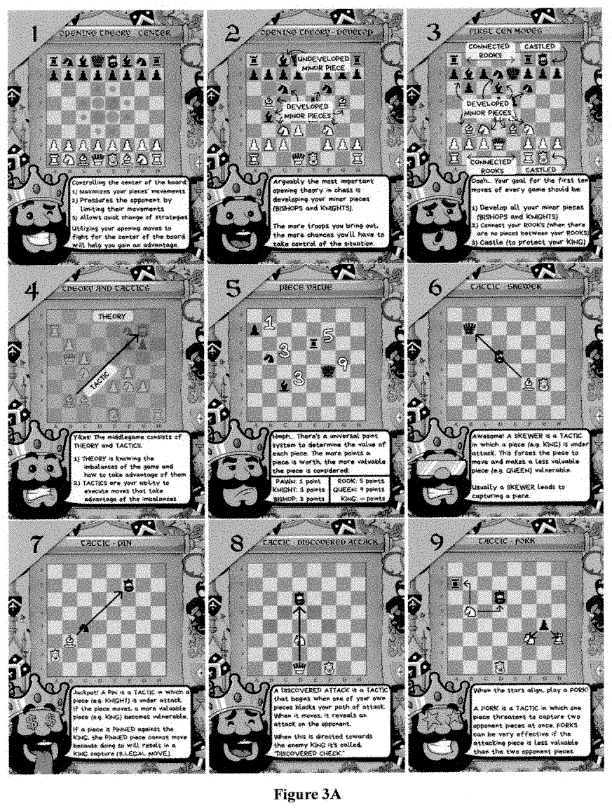

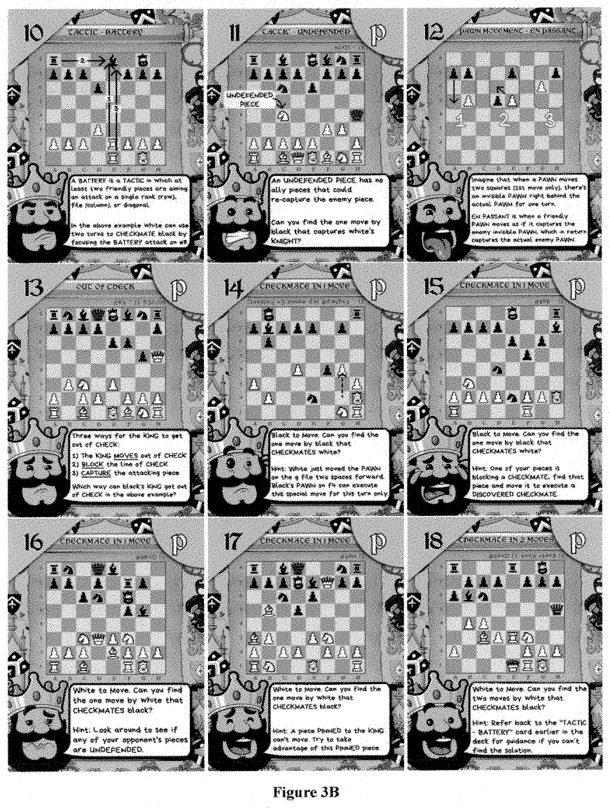

FIG. 3A reveals the first half of the cards in a deck, which mainly consist of cards that teaches a specific chess subject.

FIG. 3B reveals the second half of the cards in a deck, which mainly consist of cards that apply the taught chess subject from the first half of the deck.

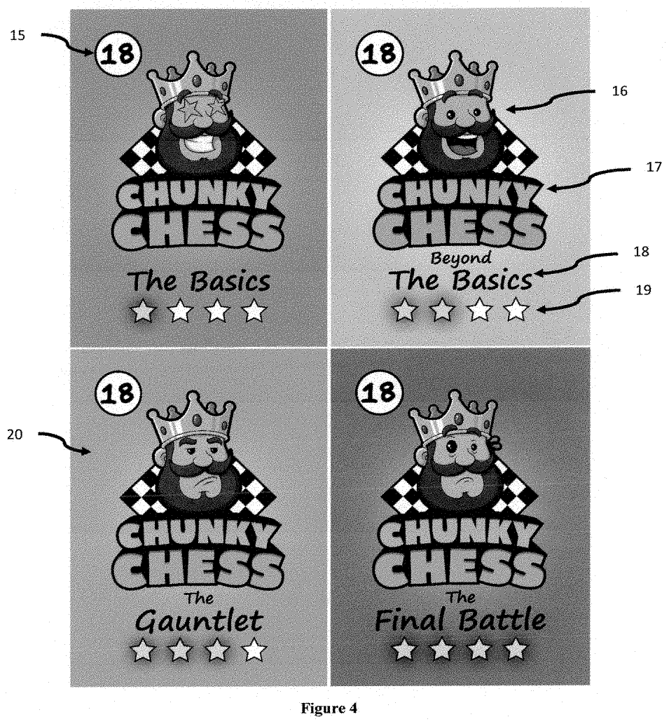

FIG. 4 reveals the general format and variants of the back-side of all four decks. Each card is numbered 15 one through eighteen, corresponding to the same number on the front side of the card. The card's back-side has a unique emoji 16, deck theme 18, difficulty level 19, and color gradient 20, specific to the deck. The difficulty level is shown by four placeholders of stars, where more stars filled inside the star-placeholder means the deck is more difficult. The “Chunky Chess” 17 title is to show that this deck belongs to the Chunky Chess brand.

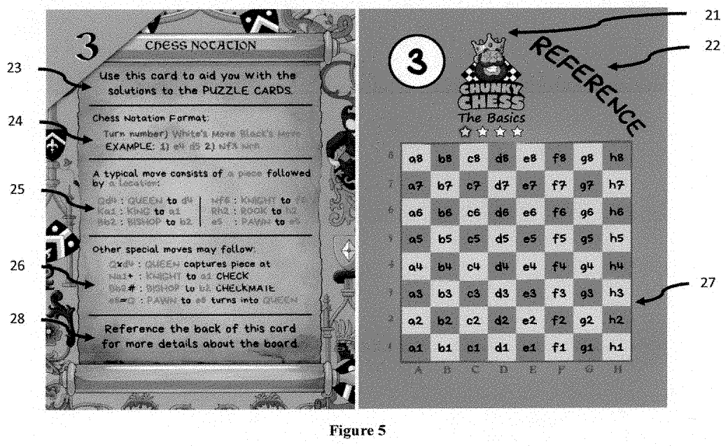

FIG. 5 reveals the front and back of special card that teaches the basics of chess notation. The front of the card is split into five sections that explain when to use the card 23, chess notation format 24, typical moves in chess notation 25, special moves in chess format 26, and that there is more useful chess notation information on the back of the card 28. On the back of the card a small design 21 indicates which deck the card belongs to, that this card is used as a reference 22, and a chess board with corresponding number and letter labels on the chess board 27.

1. A card game that uses a numeric or chromatic system to teach a specific chess theme.

2. A card game that teaches chess tactics, theory, or strategies.
A single card may show one tactic, theory, or strategy, accompanied by visual aids and/or text.

3. A card game that has chess puzzles.
There may be one or more chess puzzle(s) on a single chess card.
Chess puzzles may be, but are not limited to, “Checkmate in 1 move”, “Checkmate in 2 moves”, “Find the Best Move”, and “What's the Main Opening Move of the Sicilian Defense”.
The solutions to the chess puzzle(s) may be on the same card as the puzzle.
The chess puzzle(s) may relate to, but are not limited to, previously taught chess openings, endgames, tactics, theory, or strategies.

4. A card that explains chess notation.
The card may be a reference card for other chess cards that use chess notation.

5. A deck of cards that teaches chess based on the player's skill level.

6. A card game that annotates chess positions in written layman.
The writing may be, but not limited to, written sentences, bullet points, and paragraphs.
